(19) United States
(12) Patent Application Publication
(10) Pub. No.: US 2026/0291336 A1
(43) Pub. Date: Sep. 24, 2026

(54) Housing for a Machine, and Motor Vehicle Having Same

(71) Applicant: Bayerische Motoren Werke Aktiengesellschaft, Muenchen (DE)

(72) Inventor: Simon Eglseer, St. Pantaleon-Erla (AT)

(21) Appl. No.: 19/476,091

(22) PCT Filed: Mar. 25, 2024
(86) PCT No.: PCT/EP2024/057894

§ 371 Date: Oct. 16, 2025

(30) Foreign Application Priority Data
Apr. 21, 2023 (DE) 10 2023 110 150.1

(51) Int. Cl. H02K 9/19

(52) U.S. Cl. CPC H02K 9/19

(57) ABSTRACT

A housing for a machine includes a first shaft chamber, a hollow housing interior, and a lubricant tank. The hollow housing interior that has a control chamber region with a first tank seat. The housing interior is fluidically sealed from the first shaft chamber. A housing interior wall has a cylindrical shaft chamber outer wall. The lubricant tank has a first tank portion which is seated in the first tank seat and lies in a contour-matching manner against a first outer wall portion of the shaft chamber outer wall facing the control chamber region.

The present application is the U.S. national phase of PCT Application PCT/EP2024/057894 filed on Mar. 25, 2024, which claims priority of German patent application No. 10 2023 110 150.1 filed on Apr. 21, 2023, the entire contents of which are incorporated herein by reference.

### TECHNICAL FIELD

The present invention relates to generally to housings for machines.

### BACKGROUND

There is a need to cool or thermally condition and lubricate machines, in particular electric machines, so that the machines can be operated as efficiently as possible. In the motor vehicle sector, electric machines are used as drive or traction machines. Designing the most efficient cooling and lubrication possible for the drive machine in this case is associated with difficulties, since, due to predetermined packaging constraints, the installation space for the components of a cooling and/or lubricant circuit is limited. This means, for example, that a housing of an electric traction machine can only be provided with a particularly small-volume cooling/lubricant tank, which makes it necessary to arrange an additional cooling/lubricant tank elsewhere, as is proposed, for example, in DE 10 2020 007 6356 A1. In order to integrate both tanks into the cooling or lubricant circuit, in particular to connect them to one another, it is then necessary to construct a corresponding system of pipes and/or hoses, optionally in conjunction with a valve device. This, however, is particularly complex and requires in addition further installation space, thereby further exacerbating the packaging problem.

As a result, there is a need to provide a particularly installation-space-efficient—that is, particularly compact—solution for the particularly efficient lubrication and/or cooling of a machine.

### SUMMARY

The above-stated need, as well as others, are addressed by at least some embodiments disclosed herein. Features, advantages, and possible embodiments that are disclosed in the description for one of the subject matters of the independent claims are to be regarded-across categories and embodiments—at least analogously as features, advantages, and possible embodiments of the respective subject matter of the other independent claims, and of any possible combination of the subject matters of the independent claims, where appropriate in combination with one or more of the dependent claims.

A corresponding housing for a machine, machine comprising the housing according to the invention, and motor vehicle comprising the machine according to the invention are disclosed. In the intended installation position, the housing forms a component of the machine, which is designed, in particular, as an electric machine. For example, the electric machine is a traction machine for the motor vehicle. If the machine or traction machine is installed in its intended installation position in the motor vehicle, it forms part of the motor vehicle. The motor vehicle is therefore, in particular, a purely electrically or hybrid-electrically drivable motor vehicle.

According to a first embodiment, the housing has a first shaft chamber, through which a first shaft of the machine extends coaxially in the machine. The first shaft is, for example, designed as a first rotor shaft of the traction machine, wherein a first stator is then fixedly arranged in the first shaft chamber, and the first rotor shaft extends coaxially through the first stator and consequently through the first shaft chamber. The housing further has a hollow housing interior space that has a control chamber region for an electronic control device of the machine.

The machine comprises the electronic control device accommodated in the control chamber region, in particular in the control seat thereof. The control device is, in particular, an inverter circuit. In addition to the control seat, the control chamber region has a first tank seat. The housing interior space and the shaft chamber are furthermore fluidically sealed from one another. Since the first shaft chamber has an annular-cylindrical shape, the shaft chamber outer wall thereof is cylindrical. The shaft chamber outer wall projects into the hollow housing interior space, which means that a housing interior space wall surrounds the cylindrical shaft chamber outer wall or is partially formed by it. In addition, the housing has a lubricant tank which is provided for a lubricant circuit of the machine. The lubricant tank is therefore part of the lubricant circuit of the machine or is fluidically integrated therein. The lubricant tank has a first tank portion which is seated in the first tank seat of the control chamber region and lies in a contour-matching manner against a first outer wall portion of the cylindrical shaft chamber outer wall facing the control chamber region.

Consequently, installation space available in the housing of the machine is put to optimal use, in order to ensure highly efficient lubrication of the machine. In this case, previously unconsidered or unused space in the housing of the machine is used for the lubricant circuit, namely the inverter or control chamber, which accommodates both the electronic components of the control or inverter unit and the first tank portion of the lubricant tank. In this way, the installation volume of the housing of the machine which is in particular predetermined by packaging constraints—is not increased, while nevertheless the quantity of lubricant used in the housing is significantly increased.

According to at least one embodiment, the first tank portion has a first tank opening, and the lubricant tank comprises a second tank portion with a second tank opening. This means that the lubricant tank is formed from the first and second tank portions, which together define an overall volume of the lubricant tank. The second tank portion is arranged outside the control chamber region, namely in a second tank seat of the housing interior, and lies in a contour-matching manner against a second outer wall portion of the shaft chamber outer wall facing away from the control chamber region. The tank openings in this case bear against one another in a fluidically sealed manner, in particular directly, i.e. without a hose, pipe, or the like connecting the two tank openings to one another. In particular, the tank openings are connected to one another in a fluidically sealed manner by the tank portions being properly inserted into the respective tank seats. This two-part design of the lubricant tank enables installation space in the housing that is difficult to access to be used particularly efficiently for the lubrication and/or cooling of the machine.

In order to ensure a particularly reliable sealed

connection between the tank portions at the tank openings, at least some embodiments provide that the first tank opening and the second tank opening each have a sealing ring seat, in which a corresponding sealing ring of the lubricant tank is arranged. In particular, the sealing ring seated in the sealing ring seats is clamped between the tank portions at the tank openings. This advantageously prevents any unwanted escape of a lubricant and/or coolant from the lubricant tank. The sealing ring is, in particular, a standard part, thereby taking into account the concept of providing a particularly simply constructed lubricant circuit.

In some implementations, the housing has a second shaft chamber for a second shaft of the machine. The shaft chambers in this case are spaced apart from one another in a transverse direction (y) of the housing via the first and/or the second tank seat, wherein the lubricant tank extends in contour-matching fashion along a vertical axis (z) of the housing between the two shaft chambers. In this context, the machine may, in a further possible embodiment, be designed as a twin machine, in particular as an electric twin machine, which has a second shaft arranged in the second shaft chamber. The second shaft is, for example, designed as a second rotor shaft of the twin machine, in which case a second stator is then fixedly arranged in the second shaft chamber, and the second rotor shaft extends coaxially through the second stator and consequently through the second shaft chamber. The electric twin machine is characterized in that the control device is configured to control both rotor shafts. Due to the two rotor shafts in conjunction with two stators, the electric twin machine has a higher cooling/lubrication requirement than an electric machine having only one stator-rotor unit. With the housing having the two-part lubricant tank, the installation space available in the housing of the twin machine is utilized particularly efficiently, so that a particularly large quantity of lubricant can be advantageously accommodated in the housing.

In some embodiments, the housing has a first fastening device by means of which the first tank portion is fixed in the first tank seat. A first fastening element of the first fastening device is fixed to the housing interior wall and to the first tank portion, as a result of which the first tank portion is held particularly securely in position on the housing interior wall, in particular in the first tank seat, by means of the first fastening element.

If the lubricant tank of the housing comprises the second tank portion, the housing can have a second fastening device by means of which the second tank portion is fixed in the second tank seat. A second fastening element of the second fastening device is fixed to the housing interior wall and to the second tank portion, as a result of which the second tank portion is held particularly securely in position on the housing interior wall, in particular in the second tank seat, by means of the second fastening element.

Thanks to the fastening units, the lubricant tank is secured particularly reliably in the housing interior. Furthermore, the fastening devices are, in particular, configured to clamp the tank portions to one another along the vertical direction (z) of the housing, thereby ensuring—in particular in conjunction with the sealing ring—that the tank openings abut one another in a particularly secure and fluid-tight manner.

Further features may emerge from the claims, the figures, and the figure description. The features and feature combinations mentioned above in the description, as well as the features and feature combinations shown alone in the figure description and/or in the figures below, are not only usable in the respectively stated combination, but also in other combinations or individually, without departing from the scope of the invention.

### BRIEF DESCRIPTION OF THE DRAWINGS

FIG. 1 shows a sectional exploded view of a machine having a housing with an integrated lubricant tank, and

FIG. 2 shows a sectional view of the machine in FIG. 1.

### DETAILED DESCRIPTION

The following provides a combined description of a housing 1 for a machine 2, the machine 2 itself, and a motor vehicle (not shown) incorporating the machine 2. In the figures, identical and functionally equivalent elements are provided with the same reference signs.

The motor vehicle in this example is designed to be capable of being driven purely electrically or hybrid-electrically and has the machine 2, which is configured as an electric traction machine. In the present case, the machine 2 or traction machine is configured as an electric twin machine, the rotor-stator units (not shown) of which can be controlled by means of a common control device (not shown) of the machine 2.

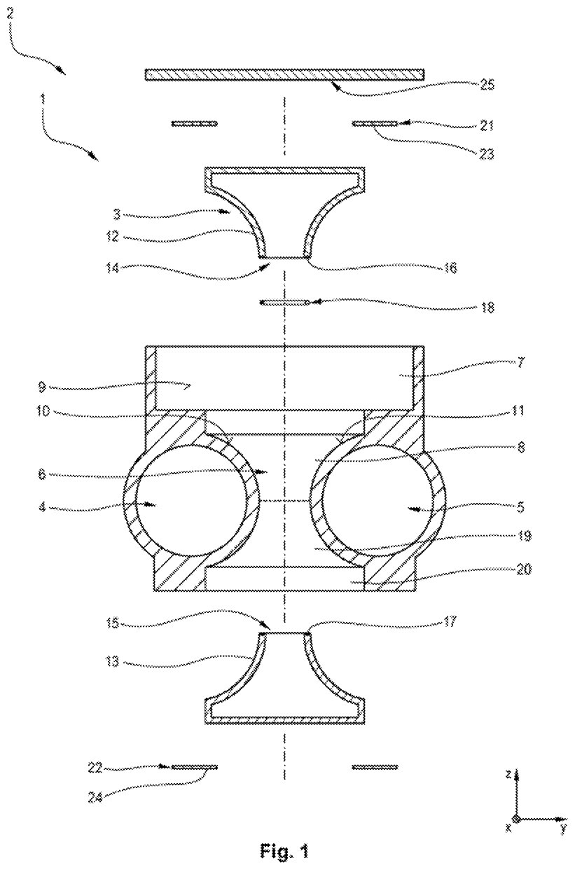

FIG. 1 shows a sectional exploded view of the electric twin machine 2, which has the housing 1 with an integrated lubricant tank 3 that is fluidically integrated into the lubricant circuit of the machine 2. In the present case, the housing 1 has a first shaft chamber 4 and a second shaft chamber 5, in each of which one of the rotor-stator units of the machine 2 is arranged. The housing 1 also has a hollow housing interior 6 which has, or is at least partially formed by, a control chamber region 7 and a first tank seat 8. The housing interior 6 and the shaft chambers 4, 5 are fluidically sealed from one another. It can also be seen from FIG. 1 that a housing interior wall 9 has cylindrical shaft chamber outer walls 10, 11 which are spaced apart from one another in a transverse direction y of the housing 1 via the first tank seat 8. In this example, the lubricant tank 3 is formed from, or assembled from, a first tank portion 12 and a second tank portion 13, wherein the tank portions 12, 13 each have a tank opening 14, 15 corresponding to one another in shape and size. At the respective tank opening 14, 15, the tank portions 12, 13 in the present example each have a respective sealing ring seat 16, 17 corresponding in shape and size to a sealing ring 18 of the lubricant tank. The first tank seat 8 and the first tank portion 12 are assigned to one another, whereas a second tank seat 19 and the second tank portion 13 are assigned to one another. The second tank seat 19 is arranged outside the control chamber region 7, for example in a further region 20 of the housing interior 6. In the present example, the housing 1 also has a first fastening device 21 and a second fastening device 22. By means of respective fastening elements 23, 24 of the fastening devices 21, 22, a respective one of the tank portions 12, 13 can be fixed in position in the associated tank seat 8, 19. FIG. 1 also shows a cover 25 of the housing 1, by means of which the housing interior 6 can be closed at the top.

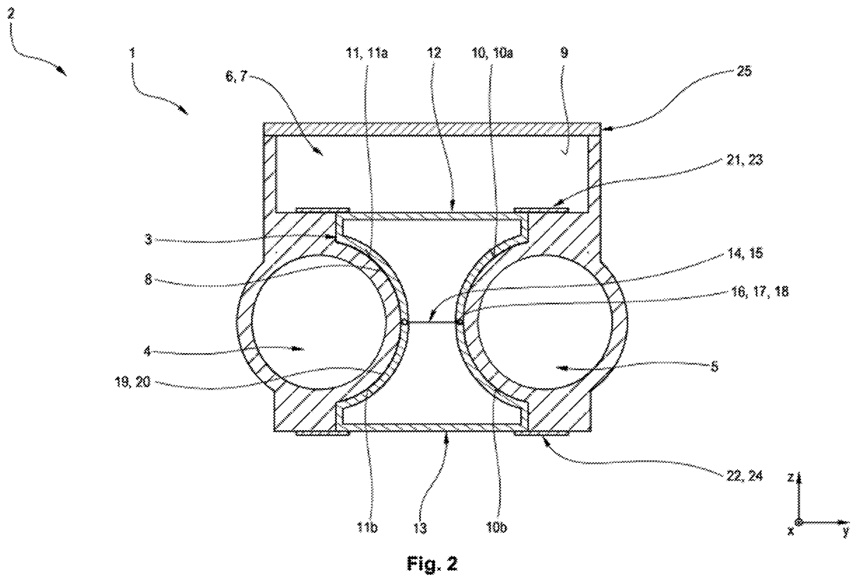

FIG. 2 shows a sectional view of the machine 2 assembled in its intended state, wherein it can be seen that the first tank portion 12, by sitting in the control chamber region 7 in the first tank seat 8, lies contiguously against a first outer wall portion 10a, 11a of the respective cylindrical shaft chamber outer wall 10, 11 facing the control chamber region 7. By being seated outside the control chamber region 7 in the second tank seat 19, the second tank portion 13 lies in a contour-matching manner against a second outer wall portion 10b, 11b of the respective shaft chamber outer wall 10, 11 which faces away from the control chamber region 7. Accordingly, the tank portions 12, 13 are shaped in accordance with the form of the housing interior 6, in particular in accordance with the shape of the shaft chamber outer walls 10, 11.

It can also be seen from FIG. 2 that the tank openings 14, 15 abut one another without any hose, pipe, or the like providing a fluidic connection between the tank portions 12, 13. Instead, the tank portions 12, 13 are fluidically connected to one another solely by being seated in their respective tank seats 8, 19. The tank portions 12, 13 thereby together form a total volume of the lubricant tank 3. Between the tank openings 14, 15, the sealing ring 18 is inserted into the respective sealing ring seat and clamped between the tank portions 12, 13, or between the tank openings 14, 15.

By means of the first fastening device 21, the first tank portion 12 is fixed in position in the first tank seat 8 and, in particular, clamped into the first tank seat 8. For this purpose, the first fastening element 23, for example a fastening ring disc or the like, is fastened both to the housing interior wall 9 and to the first tank portion 12. In addition, provision may be made for the first fastening element 23 to be fastened, in particular screwed, only to the housing interior wall 9 and to extend over the first tank portion 12. The same applies analogously to the second fastening device 22 in interaction with the second tank portion 13 or the second tank seat 19: the second fastening element 24 is, for example, fastened to both the housing interior wall 9 and the second tank portion 13. Alternatively, the second fastening element 24 may be fastened, in particular screwed, only to the housing interior wall 9 and extend over the second tank portion 13. In particular, the tank portions 12, 13 are clamped together by means of the fastening devices 21, 22, so that at the tank openings 14, 15 the connection between the tank portions 12, 13 is particularly secure and fluid-tight. Overall, it can be seen from FIG. 2 that the lubricant tank 3 extends in a contour-matching manner along a vertical axis z of the housing 1 between both shaft chambers 4, 5, with each of the tank portions 12, 13 extending contiguously between the two shaft chambers 4, 5.

By way of the housing 1, the machine 2, and the motor vehicle, a respective possibility is provided for designing cooling/lubrication for the machine 2 in a particularly space-efficient and compact manner. The core idea of the invention is to extend an oil or lubricant volume into an interior space of the machine 2 and, in so doing, in particular making use of previously unused installation space in the inverter of the machine 2. In order to avoid complex sealing, the tank portions 12, 13 are sealed and connected to one another internally and externally by simple radial and axial seals, which are preferably standard components. The manufacture and assembly of the machine 2 or the housing 1 is also particularly straightforward due to the two-part design of the lubricant tank 3: the first tank portion 12 is inserted into the inverter space, i.e. into the first tank seat 8, and screwed in place. Its tank opening 14 faces downwards, namely towards the second tank seat 19. The second tank portion 13, which may be formed as an oil module or may comprise the oil module, is inserted from below into the second tank seat 19. At the tank openings 14, 15, the tank portions 12, 13 are thereby connected to one another and sealed externally by means of the sealing ring 18 (standard component). No sealing to the inverter space is required in this case, since the tank portions 12, 13 form a fluidically closed system.

### LIST OF REFERENCE SIGNS

1 housing
2 machine
3 lubricant tank
4 first shaft chamber
5 second shaft chamber
6 housing interior
7 control chamber region
8 first tank seat
9 housing interior wall
10 first shaft chamber outer wall
10a first outer wall portion
10b second outer wall portion
11 second shaft chamber outer wall
11a first outer wall portion
11b second outer wall portion
12 first tank portion
13 second tank portion
14 first tank opening
15 second tank opening
16 first sealing ring seat
17 second sealing ring seat
18 sealing ring
19 second tank seat
20 further region
21 first fastening device
22 second fastening device
23 first fastening element
24 second fastening element
25 cover

1.-9. (canceled)

10. A housing for a machine, comprising:
a first shaft chamber,
a hollow housing interior that has a control chamber region with a first tank seat, wherein the housing interior is fluidically sealed from the first shaft chamber, and a housing interior wall has a cylindrical shaft chamber outer wall,
a lubricant tank having a first tank portion which is seated in the first tank seat and lies in a contour-matching manner against a first outer wall portion of the shaft chamber outer wall facing the control chamber region.

11. The housing as claimed in claim 10, wherein:
the first tank portion has a first tank opening; and
the lubricant tank has a second tank portion with a second tank opening which is arranged outside the control chamber region in a second tank seat of the housing interior, and lies in a contour-matching manner against a second outer wall portion of the shaft chamber outer wall facing away from the control chamber region.

12. The housing as claimed in claim 11, wherein the first tank openings bears against the second tank opening in a fluidically sealed manner.

13. The housing as claimed in claim 11, wherein:
each of the first tank opening and the second tank opening has a sealing ring seat in which a corresponding sealing ring of the lubricant tank is arranged.

14. The housing as claimed in claim 13, further comprising a second shaft chamber that is spaced apart from the first shaft chamber along a transverse direction of the housing over the first tank seat, and wherein the lubricant tank extends in a contour-matching manner between the first shaft chamber and the second shaft chamber along a vertical axis of the housing.

15. The housing as claimed in claim 14, further comprising a first fastening device configured to secure the first tank portion in the first tank seat.

16. The housing as claimed in claim 15, further comprising a second fastening device configured to fix the second tank portion in the second tank seat.

17. The housing as claimed in claim 10, further comprising a second shaft chamber that is spaced apart from the first shaft chamber along a transverse direction of the housing over the first tank seat, and wherein the lubricant tank extends in a contour-matching manner between the first shaft chamber and the second shaft chamber along a vertical axis of the housing.

18. The housing as claimed in claim 17, further comprising a first fastening device configured to secure the first tank portion in the first tank seat.

19. The housing as claimed in claim 10, further comprising a first fastening device configured to secure the first tank portion in the first tank seat.

20. The housing as claimed in claim 19, wherein:
the first tank portion has a first tank opening; and
the lubricant tank has a second tank portion with a second tank opening which is arranged outside the control chamber region in a second tank seat of the housing interior, and lies in a contour-matching manner against a second outer wall portion of the shaft chamber outer wall facing away from the control chamber region.

21. The housing as claimed in claim 20, further comprising a second fastening device configured to fix the second tank portion in the second tank seat.

22. A machine, comprising:
a housing as claimed in claim 10,
a first shaft arranged coaxially in the first shaft chamber,
a control device arranged in the control chamber region,
a lubrication circuit into which the lubricant tank is integrated.

23. The machine as claimed in claim 22, wherein: the housing has a second shaft chamber that is spaced apart from the first shaft chamber along a transverse direction of the housing over the first tank seat, and wherein the lubricant tank extends in a contour-matching manner between the first shaft chamber and the second shaft chamber along a vertical axis of the housing;
the machine is configured as an electric twin machine;
the first shaft is configured as a first rotor shaft, and a second rotor shaft of the twin machine is arranged in the second shaft chamber;
the control device is configured to control the first rotor shaft and the second rotor shaft.

24. A motor vehicle comprising the machine as claimed in claim 22.
